(19) United States
(12) Patent Application Publication
(10) Pub. No.: US 2018/0348905 A1
(43) Pub. Date: Dec. 6, 2018

(54) INSULATING PASTE FOR SUPPORTING ELECTRODE LAYER, TOUCH PANEL, AND METHOD OF MANUFACTURING TOUCH PANEL

(71) Applicant: TORAY INDUSTRIES, INC., Tokyo (JP)

(72) Inventors: Miharu ISHIHARA, Otsu-shi, Shiga (JP); Toshiya KODAMA, Otsu-shi, Shiga (JP)

(73) Assignee: TORAY INDUSTRIES, INC., Tokyo (JP)

(21) Appl. No.: 15/778,560

(22) PCT Filed: Nov. 29, 2016
(86) PCT No.: PCT/JP2016/085275

§ 371 Date: May 23, 2018

(30) Foreign Application Priority Data
Nov. 30, 2015 (JP) 2015-232768
Nov. 30, 2015 (JP) 2015-232769

(51) Int. Cl. G06F 3/044; C09D 133/02; C09D 135/02; C09D 4/06; C09D 5/00

(52) U.S. Cl. CPC G06F 3/044; C09D 133/02; C09D 135/02; G06F 2203/04111; C09D 5/00; G06F 2203/04103; C09D 4/06

(57) ABSTRACT

The present invention provides an insulating paste for supporting an electrode layer which is suitable for a process of applying a conductive paste, exposing the conductive paste through a photomask, and developing the conductive paste to form a pattern, does not generate residues of silver fine particles and the like after the development, has good adhesion to an electrode layer, and can be used without problems of visibility at a touch position of a touch panel. The present invention is an insulating paste for supporting an electrode layer containing a carboxyl group-containing resin, a polyfunctional monomer, and a photopolymerization initiator. In this insulating paste, a content of the photopolymerization initiator is 3.5% by mass to 20% by mass, a content of the carboxyl group-containing resin is 20% by mass to 35% by mass, and the carboxyl group-containing resin has a weight average molecular weight of 20,000 to 120,000.

### TECHNICAL FIELD

The present invention relates to an insulating paste for supporting an electrode layer, a touch panel, and a method of manufacturing a touch panel.

### BACKGROUND ART

In recent years, further improvement of resolution and visibility of touch position detection has been required for touch panels of smartphones and tablet terminals. As one means for meeting the requirement, a method is known in which transparent electrode patterns formed in an island shape as shown in FIG. 1 are electrically connected to each other by a bridge electrode pattern (Patent Document 1). Electrical contact is prevented by interposing an insulating layer except for a connection portion of an intersection of the transparent electrode pattern and the bridge electrode pattern. In this non-connection portion, a transparent electrode pattern layer, the insulating layer, and a bridge electrode pattern layer are stacked, and the insulating layer is required to have characteristics in which adhesion with the transparent electrode pattern layer and adhesion with the bridge electrode pattern layer are good and the insulating layer is not affected by a bridge electrode patterning process.

In general, a transparent electrode is mainly ITO (indium tin oxide) or the like. As a process of the patterning thereof, a metal thin film of ITO or the like is formed on a substrate by sputtering or the like, a photoresist made of a photosensitive resin is further applied to the surface of the thin film to be exposed through a photomask, a resist pattern is formed by development, and then etching and removal of the resist are performed.

The bridge electrode pattern is generally formed by patterning a metal such as gold or ITO or a metal oxide by a sputtering method or the like.

However, since there is a problem that the bridge electrode pattern formed of a metal or a thin film of a metal oxide has a weak resistance to bending, there has been considered a method of forming a conductive pattern (bridge electrode pattern) using a conductive paste containing metal particles. As a method of processing such a conductive paste, a photolithography method capable of achieving high-definition patterning can be mentioned. Specifically, a conductive paste is applied to be exposed through a photomask, and thus to be developed, whereby a conductive pattern is formed.

On the other hand, regarding the insulating layer, a composition assumed for a conductive pattern formed by a sputtering method or the like is disclosed (Patent Document 2).

### PRIOR ART DOCUMENTS

### Patent Documents

Patent Document 1: Japanese Patent Laid-open Publication No. 2013-254360

Patent Document 2: Japanese Patent Laid-open Publication No. 2014-2375

### SUMMARY OF THE INVENTION

### Problems to be Solved by the Invention

When a conductive paste using, for example, silver is photolithographically processed on the above-mentioned known insulating layer, silver fine particles in the conductive paste become residues in a nonconductive pattern region after development and cannot be used. In addition, there is a problem that disconnection occurs in a conductive pattern due to a step between a substrate and an insulating layer. This is remarkable when the conductive pattern is a thin film.

The present invention provides an insulating paste for supporting an electrode layer for forming an insulating layer having satisfactory visibility, which is suitable for a process of processing a conductive pattern using a conductive paste, and a touch panel which prevents disconnection of the conductive pattern and has an insulating layer member having a tapered cross sectional shape. That is, since residues of silver particles and the like are not generated after applying a conductive paste on an insulating layer for supporting an electrode layer formed using an insulating paste for supporting an electrode layer of the present invention, exposing the conductive paste through a photomask, and developing the conductive paste, the problem of visibility is suppressed, and when the cross section of the insulating layer is formed into such a tapered shape not causing the visibility problem, disconnection does not occur in a conductive pattern overlying the insulating layer, and, at the same time, the adhesion between a substrate or the insulating layer and the electrode layer is good, so that the present invention can be used as a bridge electrode portion at a touch position of a touch panel.

### Solutions to the Problems

In order to solve the above problems, the present invention provides an insulating paste described in the following (1) to (10) and a method of manufacturing a touch panel using the insulating paste.

(1) An insulating paste for supporting an electrode layer including a carboxyl group-containing resin, a polyfunctional monomer, and a photopolymerization initiator, wherein a content of the photopolymerization initiator is 3.5% by mass to 20% by mass, a content of the carboxyl group-containing resin is 20% by mass to 35% by mass, and a carboxyl group-containing resin has a weight average molecular weight of 20,000 to 120,000.
(2) The insulating paste for supporting an electrode layer according to (1), wherein the content of the photopolymerization initiator is 5% by mass to 20% by mass.
(3) A touch panel including, on a substrate, a transparent electrode, an insulating layer comprising a cured product of the insulating paste for supporting an electrode layer according to claim 1 or 2, and an electrode layer.
(4) The touch panel according to (3), wherein the insulating layer has a tapered cross-sectional shape, a width (TL) of a top portion of the insulating layer and a width (BL) of a bottom portion of the insulating layer satisfy the following relational expression, and the touch panel has a structure in which the electrode layer is disposed continuously from the bottom portion of the insulating layer to the top portion of the insulating layer:

TL×2.5≥BL≥TL×1.2.

(5) The touch panel according to (3) or (4), wherein the electrode layer contains at least silver particles and an organic resin.
(6) The touch panel according to any of (3) to (5), wherein the insulating layer has a thickness of 2.0 μm to 10 μm.
(7) The touch panel according to any of (3) to (6), wherein the electrode layer has a thickness of 0.5 μm to 3 μm.
(8) A method of manufacturing the touch panel according to any of the above (3) to (7), including steps of applying, drying, exposing and developing the insulating paste for supporting an electrode layer according to the above (1) or (2), heating the insulating paste at 120° C. to 160° C. to form an insulating layer, and then applying, drying, exposing, and developing a conductive paste to form an electrode layer.
(9) The method of manufacturing a touch panel according to (8), wherein the electrode layer is formed by heating at 120° C. to 160° C.
(10) The method of manufacturing a touch panel according to (8) or (9), wherein a viscosity of the conductive paste measured at a temperature of 25° C. and a rotation speed of 3 rpm using a B-type viscometer is in a range of 5 to 50 Pa·s.

### Effects of the Invention

By virtue of the use of an insulating paste for supporting an electrode layer of the present invention, it possible to provide a touch panel member which can suppress residue generation when a conductive paste is patterned and has satisfactory visibility, no conduction failure due to disconnection of a conductive pattern, and good adhesion to the electrode layer, a touch panel, and a method of manufacturing the same.

### BRIEF DESCRIPTION OF THE DRAWINGS

FIG. 1 is a view showing a bridge electrode structure at a touch position of a touch panel.

FIG. 2 is a view showing a front surface and a cross-sectional surface of a routing structure of the touch panel.

FIG. 3 is a view showing a cross-sectional surface of a bridge connection portion of the touch panel.

FIG. 4 is a view showing a bridging evaluation pattern of an insulating pattern and a conductive pattern.

### EMBODIMENTS OF THE INVENTION

An insulating paste for supporting an electrode layer of the present invention contains a carboxyl group-containing resin, a polyfunctional monomer, and a photopolymerization initiator and is characterized that the photopolymerization initiator is contained in an amount of 3.5% by mass to 20% by mass, and the carboxyl group-containing resin is contained in an amount of 20% by mass to 35% by mass.

The carboxyl group-containing resin contained in the insulating paste for supporting an electrode layer of the present invention refers to a monomer, an oligomer or a polymer which contains one or more unsaturated double bonds. Examples of the carboxyl group-containing resin include acryl-based copolymers. The acryl-based copolymer refers to a copolymer containing as a copolymer component an acryl-based monomer having a carbon-carbon double bond.

Examples of the acryl-based monomer having a carbon-carbon double bond include acryl-based monomers such as methyl acrylate, acrylic acid, 2-ethylhexyl acrylate, ethyl methacrylate, n-butyl acrylate, iso-butyl acrylate, iso-propane acrylate, glycidyl acrylate, N-methoxymethylacrylamide, N-ethoxymethylacrylamide, N-n-butoxymethylacrylamide, N-isobutoxymethylacrylamide, butoxy triethylene glycol acrylate, dicyclopentanyl acrylate, dicyclopentenyl acrylate, 2-hydroxyethyl acrylate, isobonyl acrylate, 2-hydroxypropyl acrylate, isodexyl acrylate, isooctyl acrylate, lauryl acrylate, 2-methoxyethyl acrylate, methoxyethylene glycol acrylate, methoxydiethylene glycol acrylate, octafluoropentyl acrylate, phenoxyethyl acrylate, stearyl acrylate, trifluoroethyl acrylate, acrylamide, aminoethyl acrylate, phenyl acrylate, phenoxyethyl acrylate, 1-naphthyl acrylate, 2-naphthyl acrylate, thiophenol acrylate or benzylmercaptan acrylate; styrenes such as styrene, p-methylstyrene, o-methylstyrene, m-methylstyrene, α-methyl styrene, chloromethyl styrene or hydroxymethyl styrene; γ-methacryloxypropyltrimethoxysilane; 1-vinyl-2-pyrrolidone; allylated cyclohexyl diacrylate; 1,4-butanediol diacrylate; 1,3-butylene glycol diacrylate; 1,6-hexanediol diacrylate; ethylene glycol diacrylate; ethylene glycol dimethacrylate; diethylene glycol diacrylate; triethylene glycol diacrylate; triethylene glycol dimethacrylate; tetraethylene glycol diacrylate; tripropylene glycol diacrylate; polyethylene glycol diacrylate; dipentaerythritol hexaacrylate; dipentaerythritol monohydroxypentaacrylate; ditrimethylolpropane tetraacrylate; glycerol diacrylate; methoxylated cyclohexyl diacrylate; neopentylglycol diacrylate; propylene glycol diacrylate; polypropylene glycol diacrylate; triglycerol diacrylate; trimethylolpropane triacrylate; epoxy acrylate monomers such as acrylic acid adducts of ethylene glycol diglycidyl ether, acrylic acid adducts of diethylene glycol diglycidyl ether, acrylic acid adducts of neopentyl glycol diglycidyl ether, acrylic acid adducts of glycerin diglycidyl ether, acrylic acid adducts of bisphenol A diglycidyl ether, acrylic acid adducts of bisphenol F or acrylic acid adducts of cresol novolac each having a hydroxyl group formed by ring-opening an epoxy group with an unsaturated acid; or compounds in which the acrylic group of the acryl-based monomer is replaced by a methacrylic group.

An alkali-soluble acryl-based copolymer soluble in an alkaline developer and the like is obtained by using as a monomer an unsaturated acid such as an unsaturated carboxylic acid. Examples of the unsaturated acid include acrylic acid, methacrylic acid, itaconic acid, crotonic acid, maleic acid, fumaric acid or vinyl acetic acetate, or acid anhydrides thereof. The acid value of the resulting acryl-based copolymer can be adjusted by increasing or reducing the amount of the unsaturated acid to be used.

By reacting carboxyl groups of the acryl-based copolymer with a compound containing an unsaturated double bond such as glycidyl (meth)acrylate, an alkali-soluble acryl-based copolymer containing a reactive unsaturated double bond on the side chain is obtained.

The carboxyl group-containing resin is required to be contained in the insulating paste for supporting an electrode layer in an amount of 20% by mass to 35% by mass. When the content is less than 20% by mass, the viscosity of the insulating paste lowers, so that it may become difficult to apply the insulating paste. When the content is more than 35% by mass, the paste viscosity is too high, so that it may become difficult to apply the paste, or it may become difficult to forma uniform film.

The molecular weight of the carboxyl group-containing resin is required to be 20,000 to 120,000 in order to maintain the viscosity of the insulating paste for supporting an electrode layer. When the molecular weight is more than 120,000, pasting by mixing a solvent may become difficult, or due to an increase in viscosity, it may become difficult to form a uniform film by coating. When the molecular weight is less than 20,000, the paste viscosity is too low, so that it may become difficult to apply the insulating paste.

The acid value of the carboxyl group-containing resin is preferably 40 mg KOH/g to 250 mg KOH/g to ensure that the compound has optimum alkali-solubility. When the acid value is less than 40 mg KOH/g, the solubility of the soluble moiety may decrease. On the other hand, when the acid value exceeds 250 mg KOH/g, the development allowance range may be narrowed. The acid value of the compound can be measured in accordance with JIS K 0070 (1992).

The insulating paste for supporting an electrode layer of the present invention contains a polyfunctional monomer. As the polyfunctional monomer, an acryl-based monomer having two or more carbon-carbon double bonds is preferably used. The number of the carbon-carbon double bonds is more preferably three or more.

Examples thereof include allylated cyclohexyl diacrylate, 1,4-butanediol diacrylate, 1,4-butanediol dimethacrylate, 1,3-butylene glycol diacrylate, 1,3-butylene glycol dimethacrylate, 1,6-hexanediol diacrylate, 1,6-hexanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, tripropylene glycol diacrylate, polyethylene glycol diacrylate, polyethylene glycol dimethacrylate, dipentaerythritol hexaacrylate, ethoxylated bisphenol A diacrylate, ethoxylated bisphenol A dimethacrylate, dipropylene glycol diacrylate, alkoxylated hexanediol diacrylate, alkoxylated neopentyl glycol diacrylate, alkoxylated aliphatic diacrylate, tricyclodecanedimethanol diacrylate, propoxylated neopentyl glycol diacrylate, dipentaerythritol monohydroxypentaacrylate, ditrimethylolpropane tetraacrylate, glycerol diacrylate, methoxylated cyclohexyl diacrylate, neopentyl glycol diacrylate, neopentyl glycol dimethacrylate, propylene glycol diacrylate, polypropylene glycol diacrylate, polypropylene glycol dimethacrylate, triglycerol diacrylate, trimethylolpropane trimethacrylate, EA-0200, EA-0300, GA-5000, and EA-HR033 of the series of fluorene acrylate OGSOL (manufactured by Osaka Gas Chemicals Co., Ltd.), NPGDA, PEG 400 DA, FM-400, R-167, HX-620, R-551, R-712, R-604, R-684, GPO-303, TMPTA, THE-330, TPA-330, PET-30, T-1420, and RP-1040 which are 2 to 4 functional groups of KAYARAD series (manufactured by Nippon Kayaku Co., Ltd.), DPHA, DPEA-12, D-310, DPCA-20, DPCA-30, DPCA-60, DPCA-120, and FM-700 which are 5 or more functional groups thereof, M-313, M-315 (aka: ethoxylated isocyanuric acid triacrylate), and M-327, M-403, M-400, M-402, M-404, M-406, M-405 (aka: DPHA), M-408, M-510, M-520, M-450, M-451, M-350, M-305, M-306, M-325, M-309, M-310, M-321, M-360, M-370, M-203S, M-208, M-211B, M-220, M-225, M-215, M-240, M-1100, M-1200, M-9050, M-8100, M-8060, M-8050, M-8030, M-6250, M-6100, M-6200, M-6500, M-1600, M-1960, M-270, M-7100, M-8560, and M-7300K of Aronix series (manufactured by Toagosei Co., Ltd.).

The polyfunctional monomer is preferably contained in the insulating paste for supporting an electrode layer in a range of 5% by mass to 40% by mass. If the content is less than 5% by mass, curing of the insulating layer may be insufficient in some cases. If the content exceeds 20% by mass, the viscosity of the insulating paste lowers, so that it may become difficult to apply the insulating paste. It is more preferable to adjust the content depending on the content of the carboxyl group-containing resin.

The insulating paste for supporting an electrode layer of the present invention contains a photopolymerization initiator. Here, the photopolymerization initiator refers to a compound which generates radicals by absorbing and decomposing short-wavelength light such as an ultraviolet ray or by undergoing a hydrogen-withdrawing reaction.

Examples of the photopolymerization initiator include 1,2-octanedione, 1-[4-(phenylthio)-2-(O-benzoyloxime)], 2,4,6-trimethylbenzoyl-diphenyl-phosphine oxide, bis(2,4,6-trimethylbenzoyl)-phenyl-phosphine oxide, ethanone, 1-[9-ethyl-6-2(2-methylbenzoyl)-9H-carbazole-3-yl]-1-(0-acetyloxime), benzophenone, methyl o-benzoylbenzoate, 4,4′-bis(dimethylamino)benzophenone, 4,4′-bis(diethylamino)benzophenone, 4,4′-dichlorobenzophenone, 4-benzoyl-4′-methyldiphenylketone, dibenzylketone, fluorenone, 2,2′-diethoxyacetophenone, 2,2-dimethoxy-2-phenylacetophenone, 2-hydroxy-2-methylpropiophenone, p-t-butyldichloroacetophenone, thioxanthone, 2-methylthioxanthone, 2-chlorothioxanthone, 2-isopropylthioxanthone, diethylthioxanthone, benzyl, benzyl dimethyl ketal, benzyl-β-methoxyethylacetal, benzoin, benzoin methyl ether, benzoin butyl ether, anthraquinone, 2-t-butylanthraquinone, 2-amylanthraquinone, β-chloroanthraquinone, anthrone, benzanthrone, dibenzosuberone, methylene anthrone, 4-azidobenzalacetophenone, 2,6-bis(p-azidebenzylidene)cyclohexanone, 6-bis(p-azidebenzylidene)-4-methylcyclohexanone, 1-phenyl-1,2-butanedione-2-(o-methoxycarbonyl)oxime, 1-phenyl-propanedione-2-(o-ethoxycarbonyl)oxime, 1-phenyl-propanedione-2-(o-benzoyl)oxime, 1,3-diphenyl-propanetrione-2-(o-ethoxycarbonyl)oxime, 1-phenyl-3-ethoxy-propanetrione-2-(o-benzoyl)oxime, Michler's ketone, 2-methyl-[4-(methylthio)phenyl]-2-morpholino-1-propanone, naphthalenesulfonyl chloride, quinolinesulfonyl chloride, N-phenylthioacridone, 4,4′-azobisisobutyronitrile, diphenyl disulfide, benzothiazole disulfide, triphenylphosphine, camphor quinone, 2,4-diethylthioxanthone, isopropylthioxanthone, carbon tetrabromide, tribromophenylsulfone, benzoyl peroxide, and combinations of a photo-reductive pigment such as eosin and methylene blue, and a reducing agent such as ascorbic acid and triethanolamine.

The photopolymerization initiator is required to be contained in the insulating paste for supporting an electrode layer in a range of 3.5% by mass to 20% by mass. The content is preferably 5% by mass or more. If the content is less than 3.5% by mass, photo-curing of the insulating layer becomes insufficient, and this becomes a factor of generating a residue when a conductive paste is processed on the insulating layer later. If the content exceeds 20% by mass, it becomes difficult to achieve high definition in the patterning of the insulating layer. It is more preferable to adjust the content depending on the contents of the carboxyl group-containing resin and the polyfunctional monomer.

The insulating paste for supporting an electrode layer of the present invention may contain a sensitizer along with the photopolymerization initiator.

Examples of the sensitizer include 2,4-diethylthioxanthone, isopropylthioxanthone, 2,3-bis(4-diethylaminobenzal)cyclopentanone, 2,6-bis(4-dimethylaminobenzal)cyclohexanone, 2,6-bis(4-dimethylaminobenzal)-4-methylcyclohexanone, Michler's ketone, 4,4-bis(diethylamino)benzophenone, 4,4-bis(dimethylamino)chalcone, 4,4-bis(diethylamino)chalcone, p-dimethylaminocinnamylideneindanone, p-dimethylaminobenzylideneindanone, 2-(p-dimethylaminophenylvinylene)isonaphthothiazole, 1,3-bis(4-dimethylaminophenylvinylene)isonaphthothiazole, 1,3-bis(4-dimethylaminobenzal)acetone, 1,3-carbonylbis(4-diethylaminobenzal)acetone, 3,3-carbonylbis(7-diethylaminocoumarin), N-phenyl-N-ethylethanolamine, N-phenylethanolamine, N-tolyldiethanolamine, isoamyl dimethylaminobenzoate, isoamyl diethylaminobenzoate, 3-phenyl-5-benzoylthiotetrazole, or 1-phenyl-5-ethoxycarbonylthiotetrazole.

The added amount of the sensitizer is preferably 1% by mass to 10% by mass. When the content of the sensitizer is in this range, the light sensitivity is sufficiently improved. On the other hand, when the added amount of the sensitizer is more than 10% by mass, excessive absorption of light at an upper portion of a coating film of the insulating paste is suppressed, and a pattern bottom portion becomes thin, so that adhesion may be reduced.

The insulating paste for supporting an electrode layer of the present invention may contain a solvent. When the insulating paste contains the solvent, the viscosity of the insulating paste for supporting an electrode layer can be suitably adjusted. The solvent may be added at the end in the process of preparing the paste. By increasing the amount of the solvent, the film thickness after drying can be reduced.

Examples of the solvent include N,N-dimethylacetamide, N,N-dimethylformamide, N-methyl-2-pyrrolidone, dimethyl imidazolidinone, dimethyl sulfoxide, diethylene glycol monoethyl ether, diethylene glycol monoethyl ether acetate (hereinafter, referred to as “DMEA”), diethylene glycol monomethyl ether acetate, γ-butyrolactone, ethyl lactate, ethylene glycol mono-n-propyl ether or propylene glycol monomethyl ether acetate. For improving the stability of the insulating paste for supporting an electrode layer, an organic solvent having a hydroxyl group is preferably contained.

Examples of the organic solvent having a hydroxyl group include terpineol, dihydroterpineol, hexylene glycol, 3-methoxy-3-methyl-1-butanol (hereinafter, referred to as “Solfit”), 2,2,4-trimethyl-1,3-pentanediol monoisobutyrate, triethylene glycol monobutyl ether, diethylene glycol mono-2-ethylhexyl ether, diethylene glycol monobutyl ether, ethylene glycol mono-2-ethylhexyl ether, ethylene glycol butyl ether, diethylene glycol ethyl ether, tripropylene glycol methyl ether, tripropylene glycol n-butyl ether, propylene glycol phenyl ether, propylene glycol methyl ether, propylene glycol ethyl ether, propylene glycol n-propyl ether, propylene glycol n-butyl ether, dipropylene glycol n-propyl ether, dipropylene glycol methyl ether, dipropylene glycol n-butyl ether, 2-ethyl-1,3-hexane diol, 1-methoxy-2-propanol, 1-ethoxy-2-propanol, diacetone alcohol, tetrahydrofurfuryl alcohol, isopropyl alcohol, n-propyl alcohol or benzyl alcohol.

The viscosity of the insulating paste for supporting an electrode layer of the present invention may be in a range which allows that the insulating paste can be applied, and when the insulating paste is applied by screen printing, the viscosity thereof is preferably 4 to 150 Pa·s, more preferably 7 to 50 Pa·s as a value measured at 3 rpm using a Brookfield type (B type) viscometer. When the viscosity is less than 4 Pa·s, it may be unable to forma coating film on the substrate. In this case, it is preferred to use a method such as spin coating by a spinner, spray coating, roll coating, offset printing, gravure printing or die coating. On the other hand, when the viscosity exceeds 150 Pa·s, irregularities are formed on the surface of the coating film so that exposure unevenness may be apt to occur.

The insulating paste for supporting an electrode layer of the present invention may contain a thermosetting compound. When the insulating paste contains the thermosetting compound, curing of the insulating film can be accelerated by heating. In addition, adhesion with the electrode layer can be improved. Examples of the thermosetting compound include epoxy resins, novolak resins, phenol resins, polyimide precursors or pre-closed ring polyimides. Epoxy resins are preferable to improve adhesion to the substrate and forma conductive pattern having high stability. By appropriately selecting a backbone of the epoxy resin, the rigidity, stiffness, and flexibility of the pattern can be controlled. Examples of the epoxy resin include ethylene glycol-modified epoxy resins, bisphenol A-type epoxy resins, brominated epoxy resins, bisphenol F-type epoxy resins, hydrogenated bisphenol A-type epoxy resins, hydrogenated bisphenol F-type epoxy resins, novolac-type epoxy resins, cycloaliphatic epoxy resins, glycidylamine-type epoxy resins, glycidyl ether-type epoxy resins or heterocyclic epoxy resins.

The added amount of the thermosetting compound relative to the carboxyl group-containing resin is preferably 1 to 100 parts by mass, more preferably 10 to 80 parts by mass, further preferably 30 to 80 parts by mass. When the added amount is 1 part by mass or more, the adhesion to the substrate is improved, and, at the same time, film curing is accelerated, whereby water resistance is improved. When the added amount exceeds 100 parts by mass, the viscosity of the paste increases with time, which may be difficult to apply the insulating paste.

The insulating paste for supporting an electrode layer of the present invention may contain additives such as a plasticizer, a leveling agent, a surfactant, a silane coupling agent, and an antifoaming agent as long as desired properties of the insulating paste are not impaired.

Examples of the plasticizer include dibutyl phthalate, dioctyl phthalate, polyethylene glycol or glycerin.

Examples of the leveling agent include special vinyl-based polymers and special acryl-based polymers.

Examples of the silane coupling agent include methyltrimethoxysilane, dimethyldiethoxysilane, phenyltriethoxysilane, hexamethyldisilazane, 3-methacryloxypropyltrimethoxysilane, 3-glycidoxypropyltrimethoxysilane or vinyltrimethoxysilane.

Next, a method of manufacturing a touch panel and a touch panel using the insulating paste for supporting an electrode layer of the present invention will be described.

The touch panel of the present invention can be manufactured by patterning an insulating paste and a conductive paste. As the patterning method, there are a printing method and a photolithographic processing method, and both are possible; however, in the case of the photolithographic processing method, it is possible to accurately match the position when a transparent electrode, an insulating layer and an electrode layer are stacked, and thus it is preferable.

The method of manufacturing a touch panel of the present invention is characterized by including applying, drying, exposing, and developing the insulating paste for supporting an electrode layer of the present invention, heating the insulating paste at 120° C. to 160° C. to form an insulating layer to form an insulating layer for supporting an electrode layer, and then applying, drying, exposing, and developing a conductive paste to form the electrode layer. When the heating temperature is lower than 120° C., the insulating layer is brittle, and defects such as chipping, cracks, and peeling may occur in the subsequent process. When the heating temperature is higher than 160° C., warpage of the substrate and a dimensional change occur, and it may be difficult to stack the electrode layer while matching the position with high accuracy.

In the method of manufacturing a touch panel of the present invention, it is preferable to apply, dry, expose, and develop a conductive paste and then heat the conductive paste at 120° C. to 160° C. to form the electrode layer. When the heating temperature is lower than 120° C., the conductivity of the electrode layer may be deteriorated. When the heating temperature is higher than 160° C., there may occur a problem in the process that warpage of the substrate and a dimensional change are liable to occur and it is difficult to stack the layer.

The touch panel of the present invention is characterized by including, on a substrate, a transparent electrode, an insulating layer formed of a cured product of the insulating paste for supporting an electrode layer of the present invention, and an electrode layer. It is preferable that the electrode layer has a structure overlying the insulating layer, and the insulating layer has a tapered shape. Further, it is preferable that a width (TL) of a top portion of the insulating layer and a width (BL) of a bottom portion of the insulating layer satisfy the following relational expression, and the touch panel has a structure in which the electrode layer is disposed continuously from the bottom portion of the insulating layer to the top portion of the insulating layer:

TL×2.5≥BL≥TL×1.2.

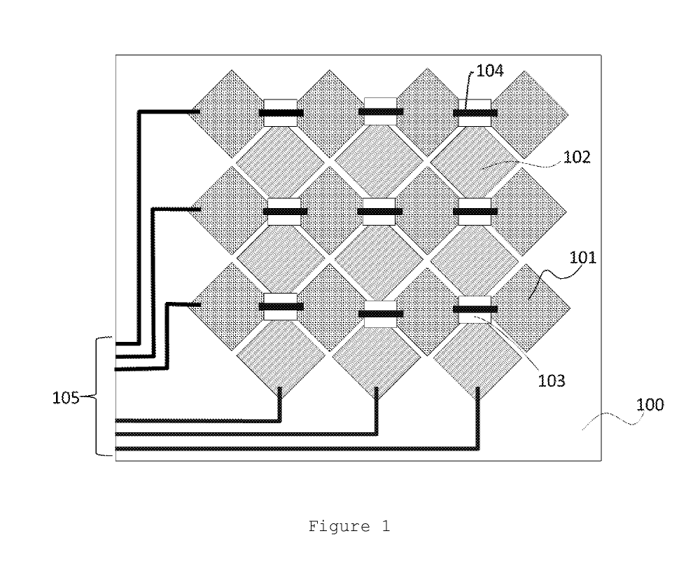

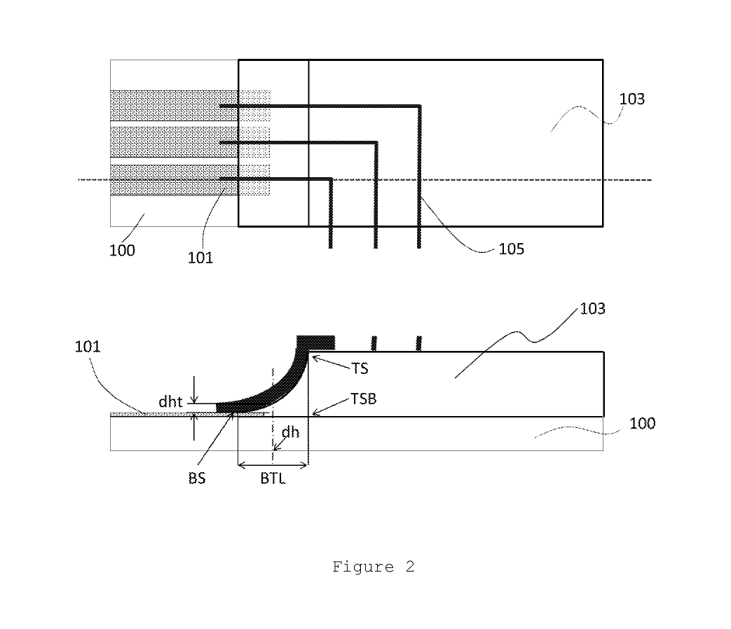

The tapered shape of the insulating layer according to the present invention will be described with reference to FIGS. 1 and 2. An upper view of FIG. 2 is a schematic view of a routing structure portion, which is a non-display region of the touch panel, as viewed from the front, and the lower view is a cross-sectional view of the dotted line portion of the upper view. On the other hand, FIG. 1 schematically illustrates one of bridge electrode connection portions of a display region which is a touch position of the touch panel. The electrode layer is represented as a routing wiring (105) or a bridge electrode pattern (104).

In FIG. 2, a transparent electrode pattern (101) is disposed on a substrate (100), the transparent electrode pattern (101) and a routing wiring (105) are connected, and the routing wiring (105) is disposed on an insulating layer (103) so as to be continuous from the bottom to the top of the insulating layer. The cross-sectional shape of the insulating layer from the bottom side to the top side is a tapered shape. Here, the cross section of the insulating layer means a cross section appearing on the assumption that the insulating layer is cut vertically on a line (the dotted line portion of FIG. 2) drawn parallel to the direction of a line provided by the routing wiring (105). As a tapered shape, it is preferable that a cross section connecting a bottom end (BS) of the insulating layer and a top end (TS) thereof is generally a curve. Here, the bottom represents the side of the substrate and/or the transparent electrode pattern. The general curve connects from the top to the bottom with a steep slope and a gentle slope. That is, a length (BTL) from an intersection (TSB) of a vertical line extending from the top end (TS) to the bottom of the insulating la, and the bottom to the bottom end (BS) of the insulating layer is required to be at least more than 0 at a portion where the routing wiring (105) overlies the insulating layer. This means that a cross-sectional angle of the insulating layer side of the top end (TS) of the insulating layer is an obtuse angle.

The shape of the general curve is considered as follows. That is, a thickness (dht) at a half-value width point (dh) of the length (BTL) from an intersection of a vertical line extending from the top end (TS) to the bottom of the insulating layer to the bottom, and the bottom to the bottom end (BS) of the insulating layer is preferably 30% or less of a thickness (t) of the insulating layer. When the thickness (dht) is 30% or less, the routing wiring (105) on the substrate or the transparent electrode pattern can overlie above the insulating layer without disconnection. This is considered to be because the conductive paste can be smoothly spread over the cross section of the insulating layer due to a general curvilinear slope of the insulating layer when the conductive paste is applied. When the film thickness exceeds 30%, it is necessary to further increase a distance between the bottom end (BS) of the insulating layer and the top end (TS) of the insulating layer to moderate the slope; however, since the width of the insulating layer is enlarged in general, visibility is deteriorated, which is not preferable.

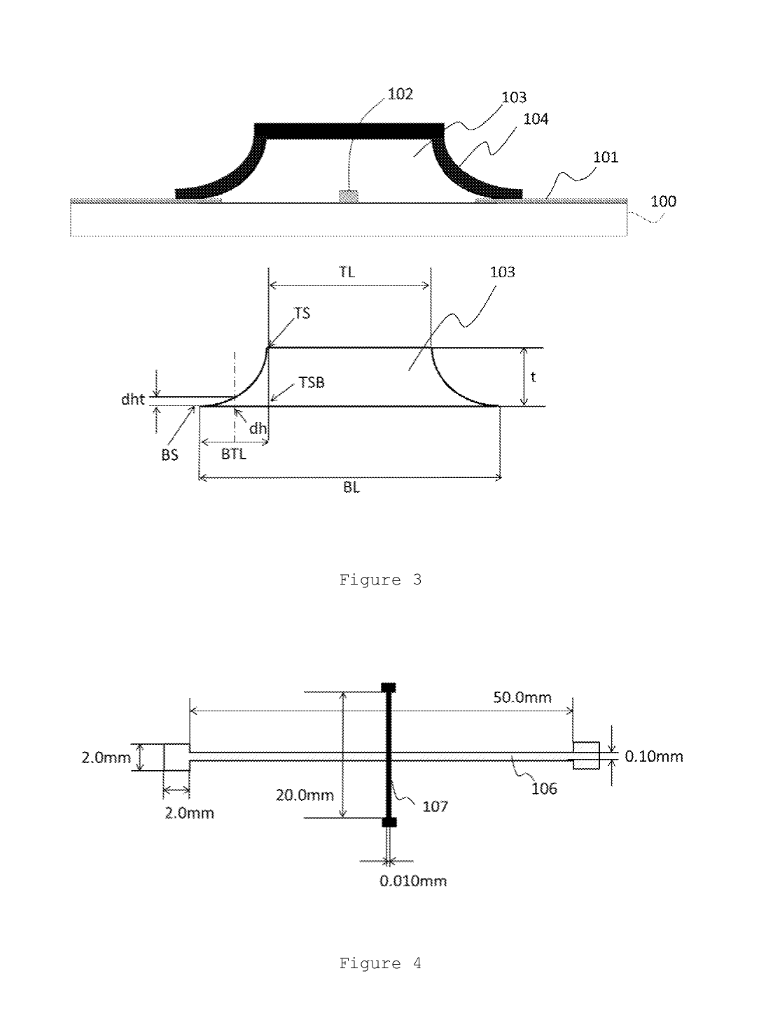

As shown in FIG. 1, the touch panel of the present invention provides a structure in which a bridge electrode connection portion is disposed in a pattern dispersed in the display region of the touch panel, and the shape of the insulating layer is tapered as shown in FIG. 3. Specifically, it is necessary that the transparent electrode pattern (101), the insulating layer (103), and the bridge electrode pattern (104) are provided on the substrate (100), the bridge electrode pattern (104) connects the transparent electrode pattern (101) through above the insulating layer (103), the insulating layer (103) has a tapered cross-sectional shape, and the width (TL) of the top portion of the insulating layer and the width (BL) of the bottom portion of the insulating layer represented by the following relational expression are satisfied. The line of the transparent electrode pattern is continuously disposed between the bottom end (BS) of the insulating layer and the top end (TS) of the insulating layer from the substrate side or the transparent electrode pattern side, overlies the top end (TS) of the insulating layer to be continuously disposed over the bottom end (BS) of the other insulating layer, and reaches the opposite substrate or transparent electrode pattern side.

TL×2.5≥BL≥TL×1.2.

If the range of the above relational expression is satisfied, there is no disconnection of the bridge electrode pattern (104), and it can be used with good visibility. The bottom width (BL) of the insulating layer is shorter than the length of the bridge electrode pattern in order that an end of the bridge electrode pattern is in contact with the transparent electrode pattern (101) and is conducted. The bottom of the insulating layer preferably has a sufficient area in order that the bridge electrode pattern (104) is insulated from the transparent electrode pattern (101) and a transparent electrode pattern (102) disposed in the vertical direction.

The insulating layer of the present invention preferably has a thickness of 2.0 μm to 10 μm. When the thickness is less than 2.0 μm, insulation properties tend to be impaired due to an increase in film defects of the insulating layer. On the other hand, when the thickness exceeds 10 μm, opacity increases to deteriorate visibility, or the electrode layer is liable to be disconnected by a step of the insulating layer, resulting in conduction failure.

The electrode layer of the present invention preferably has a thickness of 0.5 μm to 3 μm. When the thickness is less than 3 μm, the electrode layer becomes difficult to see, so that an effective use in the touch panel requiring visibility can be achieved. The thickness is more preferably 2 μm or less. When the thickness of the electrode layer is less than 0.5 μm, disconnection is liable to occur, which is not preferable.

A method of forming the insulating layer for supporting an electrode layer according to the present invention will be described. The insulating paste for supporting an electrode layer of the present invention is applied on a substrate, exposed and developed, heated at 120 to 160° C. or irradiated with light, whereby the insulating layer for supporting an electrode layer can be obtained. The insulating layer for supporting an electrode layer can be processed into a desired pattern through a photomask at the time of exposure so as to be formed into an insulating pattern. Although the line width of the insulating pattern is arbitrarily set with reference to an opening width of the mask, it is preferable that the insulating pattern is formed such that the line width is finally in a range of 10 to 2000 μm. When the line width is in this range, visibility in the display region of the touch panel is good, which is preferable. As a method of light irradiation, light of a halogen lamp, a metal halide lamp, or a xenon flash lamp is preferably used.

Examples of the substrate include polyethylene terephthalate films (hereinafter, referred to as “PET films”), polyimide films, polyester films, aramid films, epoxy resin substrates, polyether imide resin substrates, polyether ketone resin substrates, polysulfone-based resin substrates, glass substrates, silicon wafers, alumina substrates, aluminum nitride substrates, and silicon carbide substrates. A thin film layer or a decorative layer of metal such as ITO, ATO, or gold or metal oxide may be formed on the substrate, and the insulating layer may be formed in contact with these layers. The thickness of these thin film layers is 0.5 μm or less, and it is preferable to pattern them. As a patterning method, a thin film layer of a metal or a metal oxide is formed by a sputtering method, and a photoresist is then formed on the thin film layer, exposed through a photomask, and etched, thus obtaining a pattern. The decorative layer is formed mainly at the portion where the routing conductive pattern of the touch panel exists for the purpose of protecting, supporting, and blindfacing the conductive pattern and the insulating layer. As a method of forming the decorative layer, although the coating, drying, and heating are performed, photolithographic processing is also adopted.

Examples of the method of applying the insulating paste for supporting an electrode layer of the present invention include spin coating by a spinner, spray coating, roll coating, and screen printing, or coating by a blade coater, a die coater, a calender coater, a meniscus coater or a bar coater. The thickness of the resulting coating film may be appropriately determined according to, for example, a coating method, or a total solid concentration or a viscosity of the insulating paste for supporting an electrode layer. The thickness after drying is preferably 0.1 to 50 μm. Preferably, the insulating paste for supporting an electrode layer of the present invention is applied by screen printing to obtain a thickness in the above-described range. The film thickness can be measured using a probe type step profiler such as SURFCOM (registered trademark) 1400 (manufactured by TOKYO SEIMITSU CO., LTD.). More specifically, the film thickness is measured at randomly selected three positions using a probe type step profiler (measurement length: 1 mm; scanning speed: 0.3 mm/sec), and an average value thereof is defined as a thickness.

When the insulating paste for supporting an electrode layer of the present invention contains a solvent, it is preferable to volatilize the solvent by drying the resulting coating film. Examples of the method of volatilizing and removing a solvent by drying the resulting coating film include heating/drying by an oven, a hot plate, an infrared ray or the like, or vacuum drying. The heating temperature is preferably 50 to 150° C., and the heating time is preferably 1 minute to several hours. When the heating temperature is lower than 50° C., a coating film surface is soft and thus is liable to be attached to a photomask at the time of exposure, so that it is difficult to perform patterning. When the heating temperature is 150° C. or more, heat curing of the coating film progresses, which may be difficult to forma clear pattern image due to photocuring.

The obtained coating film is exposed via a pattern forming mask by a photolithography method. Alight source for exposure is preferably an i ray (365 nm), an h ray (405 nm) or a g ray (436 nm) from a mercury lamp. A photomask having an opening capable of obtaining a desired pattern is used. The material of the photomask is not limited, but it may be film or glass, or the surface may be plated with chromium or the like.

The exposure amount may be set depending on the illuminance of the light source, but it is preferably in a range of 50 mJ/cm² to 2000 mJ/cm². When the exposure amount is small, the insulating layer is insufficiently cured and may peel off during development. In the conductive pattern, conduction failure occurs.

A suitable interval may be provided between the substrate and the photomask in a range not exceeding 500 μm. If the interval is narrower than 150 μm, it is preferable from the viewpoint of preventing excessive thickening of a pattern.

The exposed coating film is developed using a developer, and an unexposed portion is dissolved and removed to form on a substrate a desired pattern with a line width of 2 μm to 50 μm. Examples of the development method include alkali development and organic development. Examples of the developer to be used for alkali development include aqueous solutions of tetramethylammonium hydroxide, diethanolamine, diethylaminoethanol, sodium hydroxide, potassium hydroxide, sodium carbonate, potassium carbonate, triethylamine, diethylamine, methylamine, dimethylamine, dimethylaminoethyl acetate, dimethylaminoethanol, dimethylaminoethyl methacrylate, cyclohexylamine, ethylenediamine, and hexamethylenediamine. To these aqueous solutions may be added a polar solvent such as N-methyl-2-pyrrolidone, N,N-dimethylformamide, N,N-dimethylacetamide, dimethyl sulfoxide or γ-butyrolactone, an alcohol such as methanol, ethanol or isopropanol, an ester such as ethyl lactate or propylene glycol monomethyl ether acetate, a ketone such as cyclopentanone, cyclohexanone, isobutyl ketone or methyl isobutyl ketone, or a surfactant.

Examples of the developer to be used for organic development include polar solvents such as N-methyl-2-pyrrolidone, N-acetyl-2-pyrrolidone, N,N-dimethylacetamide, N,N-dimethylformamide, dimethyl sulfoxide or hexamethylphosphortriamide, and mixed solutions of these polar solvents and methanol, ethanol, isopropyl alcohol, xylene, water, methyl carbitol or ethyl carbitol.

Examples of the development method include a method in which a developer is sprayed to the surface of a coating film while a substrate is left at rest or rotated, a method in which a substrate is immersed in a developer, and a method in which a substrate is immersed in a developer while an ultrasonic wave is applied thereto.

The pattern obtained by development may be subjected to a rinsing treatment with a rinsing liquid. Here, examples of the rinsing liquid include water, or aqueous solutions obtained by adding to water an alcohol such as ethanol or isopropyl alcohol, or an ester such as ethyl lactate or propylene glycol monomethyl ether acetate.

By heating the obtained substrate having the insulating layer at 120 to 160° C., an insulating layer having excellent adhesion to the substrate and excellent water resistance can be obtained. When the heating temperature is lower than 120° C., curing of a photosensitive organic compound or the like which is an organic component becomes insufficient, and the adhesion to the substrate and the water resistance are inferior. On the other hand, when the heating temperature exceeds 160° C., a substrate having low heat resistance cannot be used. The heating temperature is 160° C. or less for suppressing damage to the substrate by heating. The heating time is preferably 1 minute to several hours. Examples of the method of heating the resulting pattern include heating/drying by an oven, an inert oven, a hot plate, or an infrared ray, light irradiation with a halogen lamp, a xenon flash lamp or the like, and vacuum drying. These processings may be performed in combination.

Next, a method of forming the electrode layer according to the present invention will be described.

In a touch panel manufactured using the insulating paste for supporting an electrode layer of the present invention, for example, in use, an insulating layer is stacked on a transparent electrode layer, and an electrode layer is stacked on the insulating layer. Although the electrode layer can be formed by patterning a metal such as gold or ITO or a metal oxide by a sputtering method or the like, the electrode layer can also be formed using a conductive paste such as a non-photosensitive conductive paste or a photosensitive conductive paste.

In particular, when the insulating paste for supporting an electrode layer of the present invention is used, the method of applying the conductive paste on the insulating layer and drying, exposing, and developing the conductive paste to form the electrode layer is preferably used since residues derived from a metal powder of an unexposed portion are suppressed.

As in the above-described insulating paste for supporting an electrode layer, examples of the method of applying the conductive paste include spin coating by a spinner, spray coating, roll coating, and screen printing, or coating by a blade coater, a die coater, a calender coater, a meniscus coater or a bar coater. The thickness of the resulting coating film may be appropriately determined according to, for example, a coating method, or a total solid concentration or a viscosity of the conductive paste. The thickness after drying is preferably 0.1 to 10 μm. Preferably, the conductive paste is applied by screen printing to obtain a thickness in the above-described range.

When the conductive paste contains a solvent, it is preferable to volatilize the solvent by drying the resulting coating film. Examples of the method of volatilizing and removing a solvent by drying the resulting coating film include heating/drying by an oven, a hot plate, an infrared ray or the like, or vacuum drying. The heating temperature is preferably 50 to 150° C., and the heating time is preferably 1 minute to several hours. When the heating temperature is lower than 50° C., a coating film surface is soft and thus is liable to be attached to a photomask at the time of exposure, so that it is difficult to perform patterning. When the heating temperature is 150° C. or more, heat curing of the coating film progresses, which may be difficult to forma clear pattern image due to photocuring.

The obtained coating film is exposed via a pattern forming mask by a photolithography method. Although a specific exposure method is the same as that for the above-described insulating paste for supporting an electrode layer, a photomask is selected such that the line width after development is 1 μm to 50 μm, the interval between the substrate and the photomask is narrower than 150 μm, and as the interval becomes narrow, thickening of the pattern is suppressed, which is preferable.

The exposed coating film is developed using a developer, and an unexposed portion is removed to form on a substrate a desired pattern with a line width of 1 μm to 50 μm. As the development method, it is possible to use those mentioned above for the above-described insulating paste for supporting an electrode layer. On the insulating layer formed of the insulating paste for supporting an electrode layer of the present invention, the unexposed portion can be removed without leaving a residue in the unexposed portion after development.

By heating the obtained substrate having the electrode layer at 120 to 160° C., an electrode layer having excellent adhesion to the substrate and excellent conductivity can be obtained. When the heating temperature is lower than 120° C., curing of a photosensitive organic compound or the like which is an organic component becomes insufficient, and the adhesion to the substrate and the conductivity are inferior. On the other hand, when the heating temperature exceeds 160° C., a substrate having low heat resistance cannot be used. The heating temperature is 160° C. or less for suppressing damage to the substrate by heating. The heating time is preferably 1 minute to several hours. As the method of heating the resulting pattern, it is possible to use those mentioned above for the above-described insulating paste for supporting an electrode layer.

The conductive paste contains a metal powder, and the metal powder may be those which have conductivity. Examples of the metal powder include particles of metals such as gold, silver, copper, lead, tin, nickel, zinc, aluminum, tungsten, molybdenum, ruthenium oxide, chromium, titanium, and indium, an alloy of these metals, or composites of these metals. Among them, from the viewpoint of costs and conductive stability, silver particles are preferable. The silver particles preferably have a particle diameter of 0.1 μm to 2 μm. If the particle diameter of the silver particles is less than 0.1 μm, they tend to remain as residues in the unexposed portion. If the particle diameter is more than 2 μm, microfabrication of the conductive pattern becomes difficult, or when it is used for the display region of the touch panel, visibility deteriorates. The particle diameter is more preferably in a range of 0.2 μm to 1 μm.

The conductive paste preferably further contains an organic resin or a photopolymerization initiator. As the organic resin, a polymerizable acrylic resin is preferably contained. The same polymerizable acrylic resin and photopolymerization initiator as those contained in the insulating paste exemplified above may be used.

The conductive paste may contain additives, such as a solvent, a thermosetting compound, and a sensitizer, and as long as properties of the conductive paste are not impaired, additives such as a leveling agent, a surfactant, a silane coupling agent, and an antifoaming agent. When the conductive paste contains the solvent, the viscosity of the conductive paste can be suitably adjusted. When the amount of the solvent is increased, the thickness of the electrode layer can be reduced to 0.5 μm to 3 μm. As the solvent, the thermosetting compound, the sensitizer, the plasticizer, and the silane coupling agent, those exemplified above for the insulating paste for supporting an electrode layer may be used.

When the conductive paste is applied by screen printing, the viscosity of the conductive paste is preferably 5 to 50 Pa·s at a temperature of 25° C. and a rotation speed of 3 rpm using a Brookfield type (B type) viscometer. When the viscosity of the conductive paste is less than 5 Pa·s, it may be impossible to form a coating film on the substrate. In this case, it is preferred to use a method such as spin coating by a spinner, spray coating, roll coating, offset printing, gravure printing or die coating. On the other hand, when the viscosity exceeds 50 Pa·s, irregularities are formed on the surface of the coating film so that exposure unevenness may be apt to occur.

The insulating paste for supporting an electrode layer of the present invention is processed to obtain an insulating layer or an insulating pattern, and the conductive paste is further processed to stack the electrode layer or the conductive pattern, so that peripheral wiring for a touch panel and a touch position sensor in the display region of the touch panel can be manufactured. By using the insulating paste for supporting an electrode layer of the present invention, it is possible to accurately match the position when the insulating layer or the insulating pattern and the electrode layer or the conductive pattern are stacked.

The touch position sensor in which the insulating pattern formed from the insulating paste for supporting an electrode layer of the present invention and the bridge electrode pattern formed with high accuracy from the conductive paste are arranged can achieve suitable visibility at low cost.

Examples of the type of the touch panel include a resistive film type, an optical type, an electromagnetic induction type, and an electrostatic capacitance type.

### EXAMPLES

Hereinafter, the present invention will be described in detail with reference to examples and comparative examples, but the embodiments of the present invention are not limited thereto.

Materials used in examples and comparative examples are as follows.

[Carboxyl Group-Containing Resin]

(A-1) to (A-8) which were produced by copolymerizing acrylic acid, methyl methacrylate, and styrene at a mass ratio of 40/30/30 and adding glycidyl methacrylate to acrylic acid.

(A-1) had a weight average molecular weight of 32,000 and an acid value of 110 mg KOH/g,
(A-2) had a weight average molecular weight of 47,000 and an acid value of 50 mg KOH/g,
(A-3) had a weight average molecular weight of 69,000 and an acid value of 110 mg KOH/g,
(A-4) had a weight average molecular weight of 120,000 and an acid value of 120 mg KOH/g,
(A-5) had a weight average molecular weight of 129,000 and an acid value of 60 mg KOH/g,
(A-6) had a weight average molecular weight of 8,000 and an acid value of 100 mg KOH/g,
(A-7) had a weight average molecular weight of 19,000 and an acid value of 100 mg KOH/g, and
(A-8) had a weight average molecular weight of 24,000 and an acid value of 90 mg KOH/g.

[Photopolymerization Initiator]
IRGACURE (registered trademark) OXE-01 (hereinafter, “OXE-01”; manufactured by BASF Japan Ltd.)
IRGACURE (registered trademark) 369 (hereinafter, “IC 369”; manufactured by BASF Japan Ltd.)

[Polyfunctional Monomer]
DPHA (manufactured by Kyoeisha Chemical Co., Ltd.)
M-313 (manufactured by Toagosei Co., Ltd.)

[Solvent]
Diethylene glycol (hereinafter, referred to as “DEG”)
Diethylene glycol monobutyl ether acetate (hereinafter, referred to as “BCA”)

[Insulating Paste]

The case of Example 1 will be described below. 20.0 g of the carboxyl group-containing resin (A-1), 10 g of OXE-01, 15 g of DPHA and 30 g of DEG were added in a 100 mL clean bottle, and mixed by a rotating and revolving mixer “Awatori Rentaro” (registered trademark) (ARE-310 manufactured by Thinky Corporation) to obtain 75 g of a resin solution (solid content: 60% by mass). The composition is shown in Table 1.

[Conductive Paste]

The case of Example 1 will be described below. 10.0 g of the carboxyl group-containing resin (A-1), 0.50 g of OXE-01, and 23.5 g of BCA were added in a 100 mL clean bottle, and mixed by a rotating and revolving mixer “Awatori Rentaro” (registered trademark) (ARE-310 manufactured by Thinky Corporation) to obtain 34 g of a resin solution (solid content: 50% by mass).

34 g of the obtained resin solution and 24.5 g of silver particles were mixed together, and the mixture was kneaded using a three-roll mill (EXAKT M-50 manufactured by EXAKT) to obtain 58.5 g of a conductive paste. The viscosity after kneading was 13 Pa·s when measured under a condition of 25° C. and 3 rpm using a B-type viscometer. Table 1 shows the particle diameter (μm) of the silver particles used and the viscosity of the obtained conductive paste measured under a condition of 25° C. and 3 rpm using the B-type viscometer.

Evaluation methods used in examples and comparative examples are as follows.

<Method of Evaluating Pattern Processability>

An insulating paste was applied onto a substrate such that a dried film had a thickness of 6 μm, and the obtained coating film of the insulating paste was dried in a drying oven at 100° C. for 10 minutes. The dried coating film was exposed and developed via a photomask having a line width of 100 μm and then heated at 140° C. to obtain an insulating pattern. When a maximum line width of the obtained pattern was 200 μm or less, it was rated as excellent. When the maximum line width is 120 μm or less, it was rated as good. When the insulating pattern exceeded 200 μm and was excessively thick, it was rated as bad. When the insulating paste could not be applied, it was dated as coating failure. Exposure was performed over the entire line at an exposure amount of 150 mJ/cm² (in terms of a wavelength of 365 nm) using exposure equipment (PEM-6M manufactured by Union Optical Co., Ltd.), and development was performed by immersing a substrate in a 0.2 wt % Na₂CO₃ solution for 30 seconds, and then subjecting the substrate to a rinsing treatment with ultrapure water. The line width indicates the width (TL) of the top portion of the insulating layer.

<Method of Evaluating Residue>

An insulating paste was applied onto a substrate such that a dried film had a thickness of 6 μm, and the obtained coating film of the insulating paste was dried in a drying oven at 100° C. for 10 minutes. Thereafter, exposure and development were performed, followed by further heating at 140° C. for 1 hour to obtain an insulating layer. A conductive paste was applied on the insulating layer after heating, dried and further developed. Whether or not the coating film of the conductive paste remained after the development was evaluated with a haze meter HZ (manufactured by Suga Test Instruments Co., Ltd.). When the haze value is 1.0 to 1.5 or less, it was rated as good, and when the haze value is 1.0 or less, it was rated as excellent. As a reference, the coating film of the insulating paste not coated with the conductive paste had a haze value of 0.0. Development was performed by immersing a substrate in a 0.2 wt % Na₂CO₃ solution for 30 seconds, and then subjecting the substrate to a rinsing treatment with ultrapure water.

<Method of Evaluating Conductive Pattern Processability on Insulating Pattern>

With respect to the insulating paste rated as excellent or good in the evaluation of the pattern processability and the residue, an insulating pattern was obtained on the substrate through a photomask having a line width of 100 μm and a line length of 2 cm. The processing method was similar to the method of evaluating the pattern processability except for a photomask.

The conductive paste shown in Table 1 was applied on the insulating pattern and dried, a line of a photomask having an opening of 10 μm was aligned so as to cross the insulating pattern, exposure and development were performed, and, in addition, heating was performed at 140° C. for 1 hour, thus obtaining a conductive pattern crossing the insulating pattern. Development was performed by immersing a substrate in a 0.2 wt % Na₂CO₃ solution for 30 seconds, and then subjecting the substrate to a rinsing treatment with ultrapure water. The insulating pattern and the conductive pattern are as shown in FIG. 4.

When the line width of the conductive pattern on the substrate and the insulating pattern is 10 μm or more and 17 μm or less, and the difference is ±5% or less on average, it was rated as excellent.

<Method for Evaluating Substrate Adhesion>

An insulating paste was applied on an ITO-deposited PET film, ELECRYSTA (registered trademark) V270L-TFS (manufactured by Nitto Denko Corporation) as a substrate such that the dried film had a thickness of 6 μm, and the obtained coating film of the insulating paste was dried in a 100° C. drying oven for 10 minutes. Thereafter, exposure and development were performed, followed by further heating at 140° C. for 1 hour to obtain an insulating layer. In the insulating layer, a cut was then made in the form of 10×10 squares with a width of 1 mm. A cellophane tape (manufactured by NICHIBAN CO., LTD.) was attached at the entire location of the squares and peeled off, and a number of remaining squares was counted. Samples with the number of remaining squares being 80 or more were rated as excellent, samples with the number of remaining squares being 50 or more and less than 80 were rated as good, and samples with the number of remaining squares being less than 50 were rated as bad.

<Method of Forming and Evaluating Insulating Layer>

An insulating paste was applied onto a substrate such that a heated film had a thickness of 2, 4, 6, 8, or 10 μm, and the obtained coating film of the insulating paste was dried in a drying oven at 100° C. for 10 minutes. As the coating method, a screen printing method was used, and the film thickness was adjusted by changing a mesh diameter of a screen plate.

Thereafter, exposure was performed through a photomask having a line width of 100 μm and a line length of 5 cm. In the exposure, exposure equipment (PEM-6M manufactured by Union Optical Co., Ltd.) was used, and exposure was performed over the entire line while adjusting the exposure amount between 100 mJ/cm² (in terms of a wavelength of 365 nm) to 2000 mJ/cm² so that the width (TL) of the top portion of the insulating layer and the width (BL) of the bottom portion of the insulating layer each satisfied the top width (TL)/the bottom width (BL) (μm)=100/100, 100/120, 100/150, 100/200, 100/250, and 100/300. Subsequently, development was performed by immersing the substrate in a 0.2 wt % Na₂CO₃ solution for 30 seconds, and then subjecting the substrate to a rinsing treatment with ultrapure water. In addition, heating was performed at 140° C. to obtain a patterned insulating layer. With regard to workmanship of a pattern, it was determined that the pattern had an acceptable shape as long as the width was ±5% of a target width and the thickness (dht) at the half-value width point of the top end of the insulating layer, the vertical line extending to the bottom, and the length from the intersection of the bottom to the bottom end of the insulating layer is 30% or less of the film thickness.

<Evaluation of Disconnection in Conductive Pattern and Conduction>

The line width of the conductive pattern on the substrate and the insulating layer was observed with a microscope, and if each line width was 10 μm or more and 17 μm or less and there was no disconnection, it was rated as excellent. However, samples in which although disconnection generally did not occur, a slight disconnection seemed to occur, that is, samples in which there was a missing portion in 10% or less of the line width were rated as good.

Further, in the case where the disconnection was rated as excellent and good, conduction was evaluated. In the conduction evaluation, when compared with a line resistance value on a substrate with no insulating layer, if a difference in an average value was less than 1.5 times, it was rated as excellent, if the difference was 1.5 times or more, it was rated as good, and if the difference was twice or more, it was rated as bad. Line resistance was measured by connecting an end of the conductive pattern with a resistance meter (RM 3544 manufactured by HIOKI E.E. CORPORATION).

<Evaluation of Visibility>

A patterned insulating layer having a line width of 100 μm and a line length of 300 μm was formed at intervals of 5 mm on an ITO film substrate having a transmittance of 95% or more (550 nm) and a film thickness of 100 μm, and a conductive pattern having a line width of 10 μm and a line length of 300 μm was formed thereon.

The obtained substrate was visually observed, and it was judged whether or not the pattern was visible. In the visual observation method, the substrate is placed on a black table, and judgment is made by directly viewing the pattern while the viewpoint is separated by a distance of 30 cm. The number of observers was 5, and when 4 out of 5 observers judged that the pattern was difficult to see, it was rated as excellent. When 3 or less and 2 or more out of 5 observers judged that the pattern was difficult to see, it was rated as good. When 1 or less out of 5 observers judged that the pattern was difficult to see, it was rated as bad.

### Example 1

Using the obtained insulating paste and conductive paste, an insulating pattern for evaluation of pattern processability, a coating film for evaluation of residue, a conductive pattern for processability of the conductive pattern on the insulating pattern, a coating film for substrate adhesion, an insulating pattern for evaluation of an insulating layer, a conductive pattern for evaluation of disconnection of the conductive pattern and conduction, and a conductive pattern for evaluation of visibility were produced. The evaluation results are shown in Table 3.

### Examples 1 to 42

The insulating pastes and the conductive pastes having the compositions shown in Tables 1 to 3 were produced in the same manner as in Example 1 and evaluated in the same manner as in Example 1, and the evaluation results are shown in Tables 4 to 6.

### Comparative Examples 1 to 9

The insulating pastes and the conductive pastes having the compositions shown in Table 3 were produced in the same manner as in Example 1 and evaluated in the same manner as in Example 1, and the evaluation results are shown in Table 6.

TABLE 1

| | Insulating paste | | | | | | | | | | | |
|---|---|---|---|---|---|---|---|---|---|---|---|---|
| | | | | | Multi- | | Photo- | | | | Conductive | |
| | | | | | functional | | polymerization | | | | paste | |
| | Carboxyl group-containing resin | | | | monomer | | initiator | | Solvent | | Silver | |
| | | Weight | Acid | Pro- | | Pro- | | Pro- | | Pro- | particle | |
| | | average | value | portion | | portion | | portion | | portion | Particle | Vis- |
| | | molecular | (mgKOH/ | (mass | | (mass | | (mass | | (mass | diameter | cosity |
| | Type | weight | g) | %) | Type | %) | Type | %) | Type | %) | (μm) | Pa · s |
| Example 1 | (A-1) | 32,000 | 110 | 27 | DPHA | 20 | OXE-01 | 13 | DEG | 40 | 0.2 | 13 |
| Example 2 | (A-1) | 32,000 | 110 | 27 | DPHA | 20 | IC369 | 20 | BCA | 33 | 0.2 | 13 |
| Example 3 | (A-3) | 69,000 | 110 | 27 | DPHA | 20 | OXE-01 | 5 | DEG | 48 | 1 | 12 |
| Example 4 | (A-2) | 47,000 | 50 | 27 | DPHA | 20 | IC369 | 15 | BCA | 38 | 1 | 12 |
| Example 5 | (A-3) | 69,000 | 110 | 27 | DPHA | 20 | OXE-01 | 10 | DEG | 43 | 1.9 | 10 |
| Example 6 | (A-1) | 32,000 | 110 | 27 | M-313 | 20 | IC369 | 20 | BCA | 33 | 1.9 | 10 |
| Example 7 | (A-1) | 32,000 | 110 | 27 | M-313 | 20 | OXE-01 | 15 | DEG | 38 | 0.5 | 13 |
| Example 8 | (A-1) | 32,000 | 110 | 27 | DPHA | 20 | IC369 | 15 | BCA | 38 | 0.5 | 13 |
| Example 9 | (A-2) | 47,000 | 50 | 27 | DPHA | 20 | IC369 | 15 | BCA | 38 | 0.5 | 13 |
| Example 10 | (A-3) | 69,000 | 110 | 27 | DPHA | 20 | IC369 | 15 | BCA | 38 | 0.5 | 13 |
| Example 11 | (A-4) | 120,000 | 120 | 27 | DPHA | 20 | IC369 | 15 | BCA | 38 | 0.5 | 13 |
| Example 12 | (A-3) | 69,000 | 110 | 22 | DPHA | 20 | OXE-01 | 13 | BCA | 45 | 0.5 | 13 |
| Example 13 | (A-1) | 32,000 | 110 | 33 | DPHA | 20 | OXE-01 | 13 | BCA | 34 | 0.5 | 13 |
| Example 14 | (A-1) | 32,000 | 110 | 33 | DPHA | 5 | OXE-01 | 13 | BCA | 49 | 0.5 | 13 |
| Example 15 | (A-3) | 69,000 | 110 | 27 | DPHA | 40 | OXE-01 | 13 | BCA | 20 | 0.5 | 13 |
| Example 16 | (A-1) | 32,000 | 110 | 27 | DPHA | 20 | OXE-01 | 5 | DEG | 48 | 3.0 | 7 |
| Example 17 | (A-1) | 32,000 | 110 | 27 | DPHA | 20 | OXE-01 | 13 | DEG | 40 | 0.05 | 25 |

TABLE 2

| | Insulating paste | | | | | | | | | | | |
|---|---|---|---|---|---|---|---|---|---|---|---|---|
| | | | | | Multi- | | Photo- | | | | Conductive | |
| | | | | | functional | | polymerization | | | | paste | |
| | Carboxyl group-containing resin | | | | monomer | | initiator | | Solvent | | Silver | |
| | | Weight | Acid | Pro- | | Pro- | | Pro- | | Pro- | particle | |
| | | average | value | portion | | portion | | portion | | portion | Particle | Vis- |
| | | molecular | (mgKOH/ | (mass | | (mass | | (mass | | (mass | diameter | cosity |
| | Type | weight | g) | %) | Type | %) | Type | %) | Type | %) | (μm) | Pa · s |
| Example 18 | (A-1) | 32,000 | 110 | 27 | DPHA | 20 | OXE-01 | 13 | BCA | 40 | 0.2 | 13 |
| Example 19 | (A-1) | 32,000 | 110 | 27 | DPHA | 20 | OXE-01 | 13 | BCA | 40 | 0.5 | 13 |
| Example 20 | (A-1) | 32,000 | 110 | 27 | DPHA | 20 | OXE-01 | 13 | BCA | 40 | 1.0 | 12 |
| Example 21 | (A-1) | 32,000 | 110 | 27 | DPHA | 20 | OXE-01 | 13 | BCA | 40 | 1.9 | 10 |
| Example 22 | (A-1) | 32,000 | 110 | 27 | DPHA | 20 | OXE-01 | 13 | BCA | 40 | 2.5 | 7 |
| Example 23 | (A-1) | 32,000 | 110 | 27 | DPHA | 20 | OXE-01 | 13 | BCA | 40 | 0.05 | 25 |
| Example 24 | (A-1) | 32,000 | 110 | 27 | DPHA | 20 | OXE-01 | 20 | BCA | 40 | 0.5 | 17 |
| Example 25 | (A-1) | 32,000 | 110 | 27 | DPHA | 20 | OXE-01 | 5 | BCA | 40 | 0.5 | 22 |
| Example 26 | (A-1) | 32,000 | 110 | 27 | DPHA | 20 | OXE-01 | 13 | BCA | 40 | 0.5 | 13 |
| Example 27 | (A-1) | 32,000 | 110 | 27 | DPHA | 20 | OXE-01 | 13 | BCA | 40 | 0.5 | 13 |
| Example 28 | (A-1) | 32,000 | 110 | 27 | DPHA | 20 | OXE-01 | 13 | BCA | 40 | 0.5 | 13 |
| Example 29 | (A-1) | 32,000 | 110 | 27 | DPHA | 20 | OXE-01 | 13 | BCA | 40 | 0.5 | 13 |
| Example 30 | (A-1) | 32,000 | 110 | 27 | DPHA | 20 | OXE-01 | 13 | BCA | 40 | 0.1 | 18 |
| Example 31 | (A-1) | 32,000 | 110 | 27 | DPHA | 20 | OXE-01 | 13 | BCA | 40 | 0.5 | 13 |
| Example 32 | (A-1) | 32,000 | 110 | 27 | DPHA | 20 | OXE-01 | 13 | BCA | 40 | 0.5 | 13 |
| Example 33 | (A-1) | 32,000 | 110 | 27 | DPHA | 20 | OXE-01 | 13 | BCA | 40 | 0.5 | 13 |

TABLE 3

| | Insulating paste | | | | | | | | | | | |
|---|---|---|---|---|---|---|---|---|---|---|---|---|
| | | | | | Multi- | | Photo- | | | | Conductive | |
| | | | | | functional | | polymerization | | | | paste | |
| | Carboxyl group-containing resin | | | | monomer | | initiator | | Solvent | | Silver | |
| | | Weight | Acid | Pro- | | Pro- | | Pro- | | Pro- | particle | |
| | | average | value | portion | | portion | | portion | | portion | Particle | Vis- |
| | | molecular | (mgKOH/ | (mass | | (mass | | (mass | | (mass | diameter | cosity |
| | Type | weight | g) | %) | Type | %) | Type | %) | Type | %) | (μm) | Pa · s |
| Example 34 | (A-1) | 32,000 | 110 | 27 | DPHA | 20 | OXE-01 | 13 | BCA | 40 | 0.5 | 13 |
| Example 35 | (A-1) | 32,000 | 110 | 27 | DPHA | 20 | OXE-01 | 13 | BCA | 40 | 0.2 | 13 |
| Example 36 | (A-1) | 32,000 | 110 | 27 | DPHA | 20 | OXE-01 | 13 | BCA | 40 | 0.2 | 13 |
| Example 37 | (A-1) | 32,000 | 110 | 27 | DPHA | 20 | OXE-01 | 13 | BCA | 40 | 0.2 | 13 |
| Example 38 | (A-1) | 32,000 | 110 | 27 | DPHA | 20 | OXE-01 | 13 | BCA | 40 | 0.5 | 13 |
| Example 39 | (A-8) | 24,000 | 90 | 27 | DPHA | 20 | OXE-01 | 13 | BCA | 40 | 0.5 | 13 |
| Example 40 | (A-8) | 24,000 | 90 | 27 | DPHA | 20 | OXE-01 | 13 | BCA | 40 | 0.5 | 13 |
| Example 41 | (A-3) | 69,000 | 110 | 20 | DPHA | 15 | OXE-01 | 20 | BCA | 25 | 0.5 | 13 |
| Comparative | (A-1) | 32,000 | 110 | 27 | DPHA | 20 | IC369 | 25 | BCA | 28 | 0.5 | 13 |
| Example 1 | | | | | | | | | | | | |
| Comparative | (A-3) | 69,000 | 110 | 33 | DPHA | 20 | IC369 | 3 | BCA | 44 | 0.5 | 13 |
| Example 2 | | | | | | | | | | | | |
| Comparative | (A-1) | 32,000 | 110 | 37 | DPHA | 18 | IC369 | 20 | BCA | 25 | 0.5 | 13 |
| Example 3 | ._. | | | | | | | | | | | |
| Comparative | (A-1) | 32,000 | 110 | 15 | DPHA | 20 | IC369 | 20 | BCA | 45 | 0.5 | 13 |
| Example 4 | | | | | | | | | | | | |
| Comparative | (A-1) | 32,000 | 110 | 15 | DPHA | 35 | IC369 | 20 | BCA | 30 | 0.5 | 13 |
| Example 5 | | | | | | | | | | | | |
| Comparative | (A-6) | 8,000 | 100 | 33 | DPHA | 15 | IC369 | 20 | BCA | 32 | 0.5 | 13 |
| Example 6 | | | | | | | | | | | | |
| Comparative | (A-7) | 19,000 | 100 | 33 | DPHA | 20 | IC369 | 20 | BCA | 27 | 0.5 | 13 |
| Example 7 | | | | | | | | | | | | |
| Comparative | (A-6) | 8,000 | 100 | 37 | DPHA | 15 | IC369 | 20 | BCA | 28 | 0.5 | 13 |
| Example 8 | | | | | | | | | | | | |
| Comparative | (A-5) | 129,000 | 110 | 33 | DPHA | 20 | IC369 | 20 | BCA | 27 | 0.5 | 13 |
| Example 9 | | | | | | | | | | | | |

TABLE 4

| | | | | | Insulating layer | | | | | | | |
|---|---|---|---|---|---|---|---|---|---|---|---|---|
| | | | | | | Height | | | | | | |
| | | | | | | (dht) at | | | | | | |
| | | | Conductive | | | half- | | | | | | |
| | | | pattern | | Film | value | | | Conductive | | | |
| | | | process | | thick- | width | Top | Bottom | pattern | | | |
| | Pattern | | ability on | | ness | (dh) | width | width | Film | | | |
| | process | | insulating | Substrate | (t) | 30% or | (TL) | (BL) | thickness | Dis- | Conduction | |
| | ability | Residue | pattern | adhesion | μm | less of t | μm | μm | μm | connection | evaluation | Visibility |
| Example 1 | Excellent | Excellent | Excellent | Excellent | 4 | Passed | 100 | 150 | 2 | Excellent | Excellent | Excellent |
| Example 2 | Excellent | Excellent | Excellent | Excellent | 4 | Passed | 100 | 150 | 2 | Excellent | Excellent | Excellent |
| Example 3 | Excellent | Good | Good | Excellent | 4 | Passed | 100 | 150 | 2 | Excellent | Good | Good |
| Example 4 | Excellent | Excellent | Excellent | Good | 4 | Passed | 100 | 150 | 2 | Excellent | Excellent | Excellent |
| Example 5 | Excellent | Excellent | Excellent | Excellent | 4 | Passed | 100 | 150 | 2 | Excellent | Excellent | Excellent |
| Example 6 | Excellent | Excellent | Excellent | Excellent | 4 | Passed | 100 | 150 | 2 | Excellent | Excellent | Excellent |
| Example 7 | Excellent | Excellent | Excellent | Excellent | 4 | Passed | 100 | 150 | 2 | Excellent | Excellent | Excellent |
| Example 8 | Excellent | Excellent | Excellent | Excellent | 4 | Passed | 100 | 150 | 2 | Excellent | Excellent | Excellent |
| Example 9 | Excellent | Excellent | Excellent | Good | 4 | Passed | 100 | 150 | 2 | Excellent | Excellent | Excellent |
| Example 10 | Excellent | Excellent | Excellent | Excellent | 4 | Passed | 100 | 150 | 2 | Excellent | Excellent | Excellent |
| Example 11 | Excellent | Excellent | Excellent | Excellent | 4 | Passed | 100 | 150 | 2 | Excellent | Excellent | Excellent |
| Example 12 | Excellent | Excellent | Excellent | Excellent | 4 | Passed | 100 | 150 | 2 | Excellent | Excellent | Excellent |
| Example 13 | Excellent | Excellent | Excellent | Excellent | 4 | Passed | 100 | 150 | 2 | Excellent | Excellent | Excellent |
| Example 14 | Excellent | Good | Good | Excellent | 4 | Passed | 100 | 150 | 2 | Excellent | Good | Good |
| Example 15 | Excellent | Excellent | Excellent | Excellent | 4 | Passed | 100 | 150 | 2 | Excellent | Excellent | Excellent |
| Example 16 | Excellent | Excellent | Good | Excellent | 4 | Passed | 100 | 150 | 2 | Excellent | Excellent | Good |
| Example 17 | Excellent | Good | Good | Excellent | 4 | Passed | 100 | 150 | 2 | Excellent | Good | Good |

TABLE 5

| | | | Con- | | Insulating layer | | | | Con- | | | |
|---|---|---|---|---|---|---|---|---|---|---|---|---|
| | | | ductive | | | Height | | | ductive | | | |
| | | | pattern | | Film | (dht) at | | | pattern | | | |
| | | | process | | thick- | half-value | Top | Bottom | Film | | Con- | |
| | Pattern | | ability on | | ness | width (dh) | width | width | thick- | | duction | |
| | process | | insulating | Substrate | (t) | 30% or | (TL) | (BL) | ness | Dis- | eval- | |
| | ability | Residue | pattern | adhesion | μm | less oft | μm | μm | μm | connection | uation | Visibility |
| Example 18 | Excellent | Excellent | Excellent | Excellent | 4 | Passed | 100 | 150 | 2.0 | Excellent | Excellent | Excellent |
| Example 19 | Excellent | Excellent | Excellent | Excellent | 4 | Passed | 100 | 150 | 2.0 | Excellent | Excellent | Excellent |
| Example 20 | Excellent | Excellent | Excellent | Excellent | 4 | Passed | 100 | 150 | 2.0 | Excellent | Excellent | Excellent |
| Example 21 | Excellent | Excellent | Excellent | Excellent | 4 | Passed | 100 | 150 | 2.0 | Excellent | Excellent | Excellent |
| Example 22 | Excellent | Excellent | Good | Excellent | 4 | Passed | 100 | 150 | 3.0 | Excellent | Excellent | Good |
| Example 23 | Excellent | Excellent | Excellent | Excellent | 4 | Passed | 100 | 150 | 2.0 | Excellent | Excellent | Good |
| Example 24 | Excellent | Excellent | Excellent | Excellent | 4 | Passed | 100 | 200 | 2.0 | Excellent | Excellent | Excellent |
| Example 25 | Excellent | Good | Good | Excellent | 4 | Passed | 100 | 150 | 2.0 | Excellent | Excellent | Good |
| Example 26 | Excellent | Excellent | Excellent | Excellent | 2 | Passed | 100 | 150 | 2.0 | Excellent | Good | Excellent |
| Example 27 | Excellent | Excellent | Excellent | Excellent | 6 | Passed | 100 | 150 | 2.0 | Excellent | Excellent | Excellent |
| Example 28 | Excellent | Excellent | Excellent | Excellent | 8 | Passed | 100 | 150 | 2.0 | Excellent | Good | Good |
| Example 29 | Excellent | Excellent | Excellent | Excellent | 10 | Passed | 100 | 150 | 2.0 | Good | Good | Good |
| Example 30 | Excellent | Excellent | Excellent | Excellent | 4 | Passed | 100 | 150 | 0.5 | Good | Good | Excellent |
| Example 31 | Excellent | Excellent | Excellent | Excellent | 4 | Passed | 100 | 150 | 1.0 | Excellent | Good | Excellent |
| Example 32 | Excellent | Excellent | Excellent | Excellent | 4 | Passed | 100 | 150 | 1.5 | Excellent | Excellent | Excellent |
| Example 33 | Excellent | Excellent | Excellent | Excellent | 4 | Passed | 100 | 150 | 2.5 | Excellent | Excellent | Good |

TABLE 6

| | | | | | Insulating layer | | | | | | | |
|---|---|---|---|---|---|---|---|---|---|---|---|---|
| | | | | | | Height | | | | | | |
| | | | Con- | | | (dht) at | | | | | | |
| | | | ductive | | | half- | | | Con- | | | |
| | | | pattern | | Film | value | | | ductive | | | |
| | | | process | | thick- | width | Top | Bottom | pattern | | Con- | |
| | Pattern | | ability on | | ness | (dh) 30% | width | width | Film | | duction | |
| | process | | insulating | Substrate | (t) | or less | (TL) | (BL) | thickness | Dis- | eval- | |
| | ability | Residue | pattern | adhesion | μm | of t | μm | μm | μm | connection | uation | Visibility |
| Example 34 | Excellent | Excellent | Excellent | Excellent | 4 | Passed | 100 | 150 | 3.0 | Excellent | Excellent | Good |
| Example 35 | Excellent | Excellent | Excellent | Excellent | 4 | Passed | 100 | 120 | 2.0 | Good | Good | Excellent |
| Example 36 | Excellent | Excellent | Excellent | Excellent | 4 | Passed | 100 | 200 | 2.0 | Excellent | Excellent | Excellent |
| Example 37 | Excellent | Excellent | Excellent | Excellent | 4 | Passed | 100 | 250 | 2.0 | Excellent | Good | Good |
| Example 38 | Excellent | Excellent | Excellent | Excellent | 4 | Passed | 100 | 250 | 1.0 | Good | Good | Good |
| Example 39 | Excellent | Excellent | Excellent | Excellent | 6 | Passed | 100 | 100 | 2.0 | Bad | — | Good |
| Example 40 | Excellent | Excellent | Excellent | Excellent | 2 | Passed | 100 | 100 | 1.0 | Good | Bad | Excellent |
| Example 41 | Good | Excellent | Good | Good | 4 | Passed | 120 | 300 | 2.0 | Excellent | Good | Bad |
| Comparative | Bad | Good | — | Good | — | — | — | — | — | — | — | — |
| Example 1 | | | | | | | | | | | | |
| Comparative | Good | Bad | — | Good | 4 | Passed | 100 | 120 | — | — | — | Bad |
| Example 2 | | | | | | | | | | | | |
| Comparative | Coating | — | — | — | — | — | — | — | — | — | — | — |
| Example 3 | failure | | | | | | | | | | | |
| Comparative | Coating | — | — | — | — | — | — | — | — | — | — | — |
| Example 4 | failure | | | | | | | | | | | |
| Comparative | Coating | — | — | — | — | — | — | — | — | — | — | — |
| Example 5 | failure | | | | | | | | | | | |
| Comparative | Coating | — | — | — | — | — | — | — | — | — | — | — |
| Example 6 | failure | | | | | | | | | | | |
| Comparative | Coating | — | — | — | — | — | — | — | — | — | — | — |
| Example 7 | failure | | | | | | | | | | | |
| Comparative | Coating | — | — | — | — | — | — | — | — | — | — | — |
| Example 8 | failure | | | | | | | | | | | |
| Comparative | Coating | — | — | — | — | — | — | — | — | — | — | — |
| Example 9 | failure | | | | | | | | | | | |

### INDUSTRIAL APPLICABILITY

A member obtained by processing an insulating paste for supporting an electrode layer of the present invention can be suitably used as a member of a touch panel, particularly along with a bridge electrode pattern obtained by processing a conductive paste.

### DESCRIPTION OF REFERENCE SIGNS

100: Substrate
101: Transparent electrode pattern
102: Transparent electrode pattern
103: Insulating layer
104: Bridge electrode pattern
105: Routing wiring
106: Insulating pattern
107: Conductive pattern
TL: Width of top portion of insulating layer
BL: Width of bottom portion of insulating layer
BS: Bottom end of insulating layer
TS: Top end of insulating layer
TSB: Intersection of vertical line extending from top end to bottom of insulating layer and bottom
BTL: Length from intersection of a vertical line extending from top end of insulating layer to bottom and bottom to bottom end of insulating layer
dh: Half-value width point of top end of insulating layer, vertical line extending to bottom, and length from intersection of bottom to bottom end of insulating layer
dht: Thickness at half-value width point of top end of insulating layer, vertical line extending to bottom, and length from intersection of bottom to bottom end of insulating layer
t: Average thickness of insulating layer

1. An insulating paste for supporting an electrode layer comprising a carboxyl group-containing resin, a polyfunctional monomer, and a photopolymerization initiator, wherein a content of the photopolymerization initiator is 3.5% by mass to 20% by mass, a content of the carboxyl group-containing resin is 20% by mass to 35% by mass, and a carboxyl group-containing resin has a weight average molecular weight of 20,000 to 120,000.

2. The insulating paste for supporting an electrode layer according to claim 1, wherein the content of the photopolymerization initiator is 5% by mass to 20% by mass.

3. A touch panel comprising, on a substrate, a transparent electrode, an insulating layer comprising a cured product of the insulating paste for supporting an electrode layer according to claim 1, and an electrode layer.

4. The touch panel according to claim 3, wherein the insulating layer has a tapered cross-sectional shape, a width (TL) of a top portion of the insulating layer and a width (BL) of a bottom portion of the insulating layer satisfy the following relational expression, and the touch panel has a structure in which the electrode layer is disposed continuously from the bottom portion of the insulating layer to the top portion of the insulating layer:
TL×2.5≥BL≥TL×1.2.

5. The touch panel according to claim 3, wherein the electrode layer contains at least silver particles and an organic resin.

6. The touch panel according to claim 3, wherein the insulating layer has a thickness of 2.0 μm to 10 μm.

7. The touch panel according to claim 3, wherein the electrode layer has a thickness of 0.5 μm to 3 μm.

8. A method of manufacturing the touch panel according to claim 3, comprising steps of applying, drying, exposing, and developing an insulating paste for supporting an electrode layer comprising a carboxyl group-containing resin, a polyfunctional monomer, and a photopolymerization initiator, wherein a content of the photopolymerization initiator is 3.5% by mass to 20% by mass, a content of the carboxyl group-containing resin is 20% by mass to 35% by mass, and a carboxyl group-containing resin has a weight average molecular weight of 20,000 to 120,000, heating the insulating paste at 120° C. to 160° C. to form an insulating layer, and then applying, drying, exposing, and developing a conductive paste to form an electrode layer.

9. The method of manufacturing a touch panel according to claim 8, wherein the electrode layer is formed by heating at 120° C. to 160° C.

10. The method of manufacturing a touch panel according to claim 8, wherein a viscosity of the conductive paste measured at a temperature of 25° C. and a rotation speed of 3 rpm using a B-type viscometer is in a range of 5 to 50 Pa·s.
